(19) United States
(12) Patent Application Publication
(10) Pub. No.: US 2011/0083363 A1
(43) Pub. Date: Apr. 14, 2011

(54) CAPSULE, METHOD FOR PREPARING A CAPSULE, METHOD FOR PACKING BIOLOGICAL MATERIAL OF A VEGETATION SOURCE IN A CAPSULE, CULTURE CULTIVATION METHODS, AND CAPSULE USE

(76) Inventors: Jose Trias Vila, Palm City, FL (US); Livio Kuninagui Takahashi, Braganca Paulista SP (BR)

(21) Appl. No.: 12/921,121

(22) PCT Filed: Mar. 6, 2009
(86) PCT No.: PCT/BR2009/000056

§ 371 Date: Nov. 29, 2010

(30) Foreign Application Priority Data
Mar. 6, 2008 (BR) PI0800365-3

(51) Int. Cl. A01G 1/00

(52) U.S. Cl. 47/58.1 SC; 47/1.1 R

(57) ABSTRACT

The present invention refers to a capsule (1) enclosing an agrochemical (7), a method for producing the said capsule (1), a packing method of any biological form of a vegetative source (4), such as seed and/or embryo and/or spore and/or callose and/or meristem and/or a combination of these of at least one culture, for the use of a capsule (1) enclosing any biological material of a vegetative source (4) and a cultivation method of a culture employing the said capsules (1).

### TECHNICAL FIELD

This invention refers to a capsule encompassing an agrochemical for packing any biological form of a vegetative source, such as seeds and/or embryos and/or spores and/or callose and/or meristems and/or a combination of these, of at least one culture, for a production method for the said capsule, for a method of packing any biological form of a vegetative source, such as seeds and/or embryos and/or spores and/or callose and/or meristems and/or a combination of these, of at least one culture, as well as a cultivation method of the culture employing the said capsule.

This invention also refers to the use of a capsule free from agrochemicals for packing a biological form of a vegetative source, such as seeds and/or embryos and/or spores and/or callose and/or meristems and/or a combination of these, of at least one culture.

### STATE OF PRIOR ART

Under conventional cultivation when the objective is to cultivate multiple plants there is the difficulty of sowing a known number of seeds for the harvesting and commercialization of a determined number of plants present in a bunch, especially when the seeds have an irregular shape, this makes the control of the number of seeds released by the sowing machine very difficult. When the sowing machines release a greater or lesser number of seeds than that which is desired, this excess of seeds may also block the output from the machine, momentarily stopping the entire sowing process, also being that a lesser number of seeds makes the sowing uniformity difficult.

There are also difficulties in cultivating multiple plants when the seeds are of a small average size and when the seeds have irregular shapes. Some seeds, such as that of the watercress (8,000 seeds/gram), are very small, which makes very difficult to handle and to precise the location where one wishes to cultivate it, causing wastage, such as being dispersed by wind, besides generating health risks to the producer. In some cases, the seeds are of such a small size that they require a pelletization process before being planted.

Many harvests also suffer with losses due to bad weather such as heavy rain or droughts or even pests and animals that remove the seeds from the field or transfer it to an undesirable location.

These difficulties in cultivation result in uniformity sowing problems, making it difficult for the farmer to sow identical quantities of seeds for the final purpose, for example, a bunch with predetermined quantities to harvest and pack.

Added to the difficulties presented, there is, also, a tendency of the vegetables' consumers being more selective and strictest in products with quality. In this context, the searching for differentiated vegetables is growing, making the hydroponic system a promising alternative for the producer to create high qualities products and with more aggregated value.

The vegetable yield is generally done with or without soil. In this last, popularly known as hydroponic system, the producers have some advantages, as plagues fewer incidences, weather adversities damages reduction for the higher environmental control, water and fertilizer economy, production during the whole year and with a better quality than the ones produced in soil in adverse periods.

The hydroponic system most used for leafy vegetables' production, is the Nutrient Film Technique—NFT), which stands out for the practice in culture implantation and for the cleaning of picked products. This system is expanding fast in the proximities of big urban centers, where the agricultural areas are expensive, little and there is a big demand for the horticultural products.

The production of hydroponic lettuce is being replaced for others vegetables as arugula, which presents high economic return, generating a bigger profit than the lettuce's one.

This way, techniques that allow the obtaining of more vigorous and premature plants guarantee a bigger yield to the producer. That's why new technologies are being developed with the objective of providing plants more uniform, vigorous and premature.

In this manner, the present invention overcomes the abovementioned difficulties, so as to obtain cultivations from embryos, single seeds or multiple seeds, spores, callose, meristems or any biological vegetative form and of preference aiming for, but not limited to obtaining a determined number of units in each bunch—for example, starting with a certain number of embryos, seeds or multiple seeds, one may obtain a bunch of watercress with a number of desired units. This objective is achieved with the packing of the seed and/or embryo and/or spore and/or callose and/or meristem and/or any biological form of a vegetative source and/or a combination of these in capsules. Seeds packed in capsules may be shelled, film covered, treated and/or pelletized. The seed may either be pre-germinated or not and may also either be processed and/or boosted or not.

Capsules are conventionally used to administer drugs, but its use is not known in the technique for packing seed and/or embryo and/or spore and/or callose and/or meristem and/or any biological form of a vegetative source and/or combination of these. These conventionally known capsules may be used in manner never used before, to pack at least one culture of seeds and/or embryos and/or spores and/or callose and/or meristems and/or a combination of these to assist agriculture.

The capsules allow for the packing of single or multiple seeds, as in the concept of a “complete salad”, in which a determined quantity of different species of plants such as, lettuce, watercress and arugula are cultivated and hand harvested together. The capsules allow for the seeds and/or embryos and/or spores and/or callose and/or meristems and/or any biological form of a vegetative source and/or a combination of these to be packed together with agrochemicals—fertilizers, growth stimulants, ultraviolet filters, among others. The agrochemical incorporated into the capsule housing the seeds and/or embryos and/or spores and/or callose and/or meristems and/or any biological form of a vegetative source and/or a combination of these are selected according to the type of disease and/or deficiency that the cultivation is subject to during the pre and/or post germination period.

### OBJECTIVES OF THE INVENTION

The first objective of the invention is to furnish a capsule that is able to assist in the growth control and combat diseases, weeds, pests as well as facilitate the cultivation of different cultures, offering greater precision and speed in cultivation, with a reduction in spraying agrochemicals over the cultures onto the soil or substrate.

The second objective of the invention is to furnish a packing method of any biological form of a vegetative source, such as seeds and/or embryos and/or spores and/or callose and/or meristems and/or combination of these, together with the agrochemicals and/or water and/or substrates in the abovementioned capsule.

A third objective of this invention is to furnish a method of cultivating cultures using the abovementioned capsule, making cultivation more productive with a reduction in losses, more precise and secure. As the cultivation method of cultures use biodegradable capsules and reduces the number of agrochemical sprayings, this deals with an environment friendly manner of cultivation.

A fourth objective of this invention is the use of the conventionally known capsule, without agrochemicals, for the packing of any biological form of a vegetative source, such as seeds and/or embryos and/or spores and/or callose and/or meristems and/or combination of these.

A fifth objective of this invention is to furnish a more productive cultivation method with a reduction in losses, more precise and safer of at least one culture starting with any biological form of a vegetative source, such as seeds and/or embryos and/or spores and/or callose and/or meristems and/or combination of these.

### A BRIEF DESCRIPTION OF THE INVENTION

The first objective of this invention is achieved through a capsule for cultivation enclosing an agrochemical.

The second objective of this invention is achieved through a preparation method of a capsule as mentioned above, encompassing a step of (i) mixing at least one agrochemical with the structural ingredient.

The third objective of this invention is achieved through a packaging method of any biological form of a vegetative source in a capsule, as mentioned above, encompassing (i) feeding at least one biological form of a vegetative source (4) in the said capsule.

The fourth objective of this invention is achieved through a cultivation method of a culture encompassing in applying in a substrate a capsule as mentioned above.

The fifth objective of this invention is achieved through the use of a capsule, without an agrochemical, for the packing of any biological form of a vegetative source, such as seeds and/or embryos and/or spores and/or callose and/or meristems and/or combination of these, for horizontal or vertical application into the soil or substrate for the cultivation of a culture.

### DESCRIPTION OF THE FIGURES

This invention will be described as follows in greater detail, with reference to the attached drawings, in which:

FIG. 1—represents two joined semi-capsules for the packing of seeds;

FIG. 2—represents three semi-capsules, with one of them being the substrate for the packing of seeds;

FIG. 3—represents multiple semi-capsules, with one of them being but not limited to the substrate for packing the seeds;

FIG. 4—represents two semi-capsules, with one of them enclosing a germination substrate;

FIG. 5—represents two semi-capsules, with one of them enclosing a germination substrate and seeds;

FIG. 6—represents one semi-capsule enclosing a compacted substrate cylinder;

FIG. 7—represents one closed semi-capsule enclosing a closed reservoir for a liquid;

FIG. 8—represents two semi-capsules enclosing pesticides, a compacted substrate cylinder and seeds;

FIG. 9—represents three semi-capsules and/or multiple semi-capsules and a compacted substrate cylinder;

FIG. 10—represents two semi-capsules enclosing an inert and/or active material either solid or liquid;

FIG. 11—represents the semi-capsule in FIG. 10 in a vertical direction in the substrate;

FIG. 12—represents one semi-capsule enclosing seed and/or embryo and/or spore and/or callose and/or meristem and/or any biological form of a vegetative source and/or a combination of these and a compacted substrate cylinder;

FIG. 13—represents the semi-capsule in FIG. 12 after the substrate has expanded;

FIG. 14—represents capsule enclosing seed and/or embryo and/or spore and/or callose and/or meristem and/or any biological form of a vegetative source and/or combination of these, a compacted substrate and water and/or other liquids and/or aqueous solutions;

FIG. 15—represents one semi-capsule enclosing closed chambers;

FIG. 16—represents a capsule in a circular shape;

FIG. 16.1—represents a capsule in an oval shape;

FIG. 16.2—represents a capsule in a square shape;

FIG. 17—represents the sowing in a coconut fiber substrate of shelled seeds packed in vertical and horizontal positions;

FIG. 18—represents the seeds in FIG. 17 after a period of 7 days;

FIG. 19—represents one expansion of the shelled seeds in FIG. 17;

FIG. 20—represents one expansion of the seeds packed in the vertical position in FIG. 17;

FIG. 21—represents one expansion of the seeds packed in the horizontal position in FIG. 17;

FIG. 22—represents seedlings from the shelled seeds in the substrate after a 32-day period;

FIG. 23—represents seedlings from seeds packed in the vertical position in the substrate after a 32-day period;

FIG. 24—represents seedlings from seeds packed in the horizontal position in the substrate after a 32-day period;

FIG. 25—represents seedlings from the shelled seeds in the vertical and horizontal positions sown in phenolic foam directly into the hydroponics pipes;

FIG. 26—Large Leaf Arugula' seedlings produced in phenolic foam;

FIG. 27.1—Plants of nude seed (Control Treatment-T);

FIG. 27.2—Plants of pelleted seeds in capsule (Treatment 1);

FIG. 27.3—Plants of pelleted seeds with 9 mg of 04-14-08, 9 mg of thermophosphate and 2 mg of Ecogel in capsule (Treatment 2);

FIG. 27.4—Plants of pelleted seeds with monoamonium phosphate (2% of weight seeds) in capsule (Treatment 3);

FIG. 27.5—Plants of pelleted seeds with monoamonium phosphate (2% of weight seeds), 9 mg of 04-14-08, 9 mg of thermophosphate and 2 mg de Ecogel (Treatment 4)

FIG. 28.1—Graphic illustrating the height of plants from Treatment 2 over the time;

FIG. 28.2—Graphic illustrating the stem of plants from Treatment 2 over the time;

FIG. 28.3—Graphic illustrating the fresh weight of plants from Treatment 2 over the time;

FIG. 28.4—Graphic illustrating the dry weight of plants from Treatment 2 over the time;

FIG. 28.5—Graphic illustrating the leaves number of plants from Treatment 2 over the time;

FIG. 28.6—Graphic illustrating the leaf area of plants from Treatment 2 over the time.

### A DETAILED DESCRIPTION OF THE INVENTION

This invention refers to one capsule for cultivation of a culture enclosing agrochemical 7.

The capsule for this invention may enclose any biological form of a vegetative source, such as seed, embryo, spore, callose, meristem or a combination of these; these cultures may be of the same or different genus, families and species.

The capsules allow for greater control over germination speeds of the said biological form from a vegetative source according to humidity and environmental temperature, these increase the germination uniformity of the cultivar as well as the number of useful plants, besides serving as an identification system for the product to be sown. The capsules for packing any biological form from a vegetative source 4 do not break during handling, such as packing and transport.

The seeds to be used in capsules may be chosen from shelled seed, coated, pelletized, film covered, encrusted or a mixture of these, they may be germinated, non-germinated or pre-germinated or any form of processed seed.

There are many usage possibilities of various seeds together in the capsules, being that the seeds from vegetables, cereals, flowers, fruit, legumes and forestry species, as for example, lettuce, arugula, watercress, wild chicory, tomato, sweet pepper, melon, parsley, cabbage, cauliflower, broccoli, the so called “baby leaf” (these are leaves that are prematurely harvested). Seeds packed in the capsules may be in their natural state, treated, film covered, encrusted, pelletized or covered in gels. The capsule may, depending on the seed to be cultivated, be sown at a depth the same as its thickness and without being covered.

The use of any biological form from a vegetative source, such as seed and/or embryo and/or spore and/or callose and/or meristem and/or a combination of these 4 in capsules, presents innumerable advantages for the sowing of various types of cultures, such as the germination of multiple seeds in one single sowing unit, with a single precise size of capsule, thus controlling the exact number of seeds present in each capsule.

The cultivation of multiple packed seeds allows for the more precise spacing between the seeds to be controlled, so as to prevent competition between the plants for nutrients and allowing for greater precision in the control of the number of plants for species. In the case of biological forms from a vegetative source 4 with different germinating cycles, it is possible to pack one of the species in a pre-germinated mode, thus controlling the germination time and allowing for the farmer to carry out simultaneous harvesting of different species.

In the case of seeds with a small average size, its packing allows for greater control over the quantity of seed and/or embryo and/or spore and/or callose and/or meristem and/or a combination of these 4 used in the planting, in seeing that the use of the capsules facilitates the adjustment of the sowing machines so as to release the exact quantity of necessary capsules to cultivate a certain culture, assisting in the uniformity of the field in relation to the number of plants and thus preventing the sowing machines from becoming blocked. The capsules also allow for greater protection of small average sized seeds against dispersion by wind and/or rain. These characteristics allow for the farmer to harvest and pack a more homogenous bunch as to the number of units.

The dimensions and volumes of these semi-capsules 1, 1′ and 3 vary in preference of around 0.06 ml to around 1.0 L, but nevertheless not limited to these values. The exterior dimensions of the capsule vary and of preference that of around 2 mm to around 50 mm, with the empty volume being that of preferably being around from 1 to around 99% of the total volume of the capsule. The capsules may be filled with gasses such as air, oxygen, ethylene or a mixture of these and/or other gasses. Inside the capsule there may also be added substrate 2, water, aqueous solutions, agrochemicals, that may or may not be in contact with each other, as will be discussed further.

By substrate 2 it is understood as the soil itself, cellulose fiber, compressed peat, natural coconut fiber substrates, cotton fiber, a combination of these and/or any substrate 2 conventionally used in agriculture, including, but not limited to, sands optionally combined with any other natural and/or artificial substrate 2 (such as glass fiber, silica, gel, among others) and/or natural and/or processed clays (kaolin, montmorillonite, smectite, talcum, vermiculite, mica, sepiolite, bentonite, pumice stone, among others).

In a setting of the invention as illustrated by FIG. 7, one closed semi-capsule 6 may be used containing liquids, such as water that after a certain period of time will release it to the rest of the capsule. The releasing of the water or solution, for example, containing the nutrients to the rest of the capsule may be due to a different temperature, difference in pressure, difference in pH or digestive enzymes, microorganisms such as bacteria, decomposing fungi, molecules with active or passive memory may also be used to release the water. The storage of the water and/or aqueous solutions inside the capsule aims for better germination of the biological material of a vegetative source, such as seed and/or embryo and/or spore and/or callose and/or meristem and/or a combination of these 4 in deserts and arid zones, affording the cultivation better humidity and thus enabling greater harvest productivity in these regions.

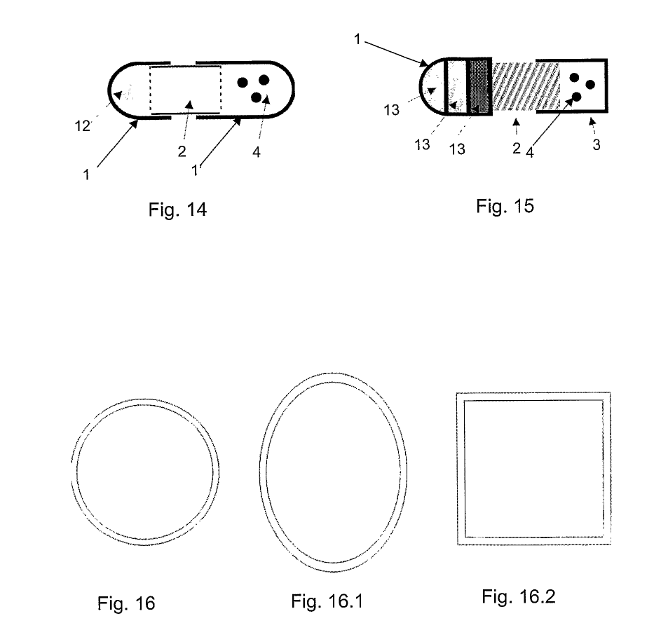

In FIG. 14, capsules made up of at least two semi-capsules 1 and 1′ may be designed so that when it comes into contact with the stored water 12 inside the capsule it hydrates the germination substrate 2 of the first phase of vegetative growth.

The capsular structure's controlled porosity varies of preference up to around 50% and favors permeability of the air with the biological material from a vegetative source in such a manner that it diminishes the possibility of lacking air. The lack of air causes a deficiency in oxygen to the seeds, which may cause anoxia (asphyxiation of the seed during the germination phase) and/or hypoxia (deficiency in oxygen). The use of plasticizers increases the structure's flexibility and controls the permeability of the capsules. The materials making up the capsule to increase its permeability may either or not be individually present in different combinations and quantities that vary from 5 to 60%, and whose particle sizes must be smaller than, but not limited to, 100 microns. The higher the concentration of structural ingredients to increase the permeability and porosity of the capsules, the greater will be its rigidity, and as a result the greater the fragility of the capsules and semi-capsules 1, 1′ and 3.

For the purposes of the invention the structural materials serve to increase the permeability and porosity of the capsules that must not be inferior of around 5% or greater than around 60% in relation to the total weight of the capsule.

The capsules of the present invention present of preference at least two semi-capsules 1, 1′ and 3, optionally making up enclosed compartments, but susceptible to communication via permeability, presenting a variable length of around 2 mm to 50 mm and a diameter varying around 2 mm to 50 mm. This configuration does not limit the invention, and may among other possible configurations, be a semi-capsule in a cylindrical substrate. During the forming of the capsules or semi-capsules 1, 1′ and 3, the level of viscosity of the mixture is of great importance. The capsules and/or semi-capsules 1, 1′ and 3 must be prepared and have a viscosity so that the thickness of the capsules and/or semi-capsules 1, 1′ and 3 are greater than that of around 15 microns and less than that of around 250 microns, thus allowing for the capsules to support the pressure of the column of capsules during its storage and transport and thus guaranteeing that the plants, when germinated, break the capsules.

The particles inside the capsules, such as natural shelled or pre-germinated seeds and/or pelletized natural or pre-germinated seeds with pesticides, fungicides, bactericides, fertilizers, growth stimulants, biological materials or osmotic gels, may vary from a colloidal form to particles and/or fibers of up to 6 mm in diameter.

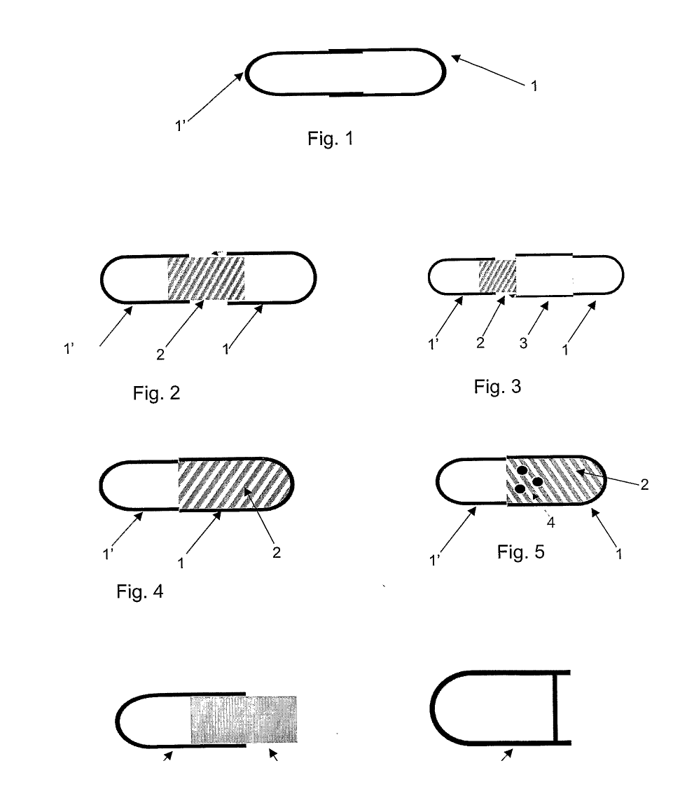

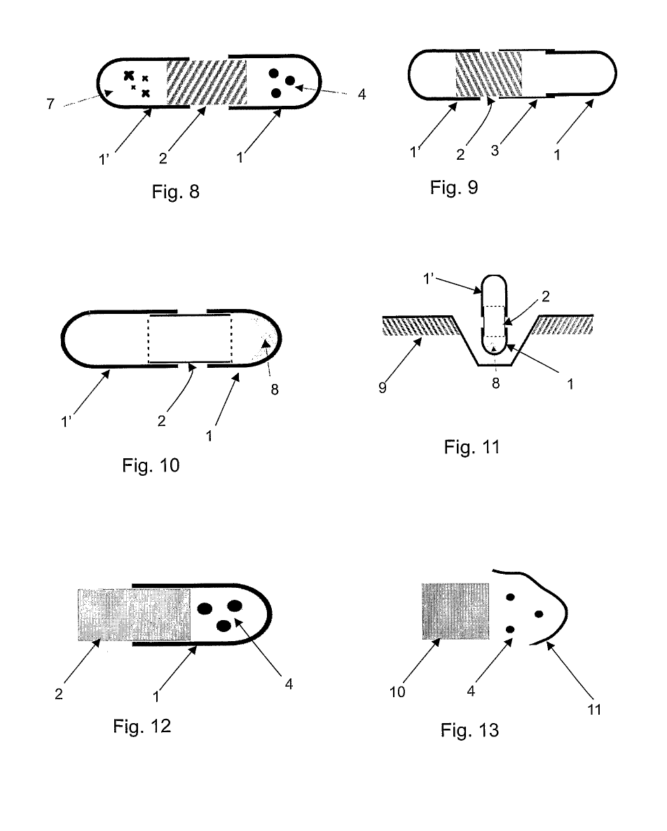

The capsules of this invention may be made up of at least one semi-capsule 1, 1′ and 3, and may have various sizes and shapes, such as spherical, oblong, cylindrical, flat or oval, as a coin and combinations of different shapes and sizes, as shown in the illustrations in FIGS. 16, 16.1 and 16.2. FIG. 1 illustrates a capsule made up of two semi-capsules 1 and 1′, now FIGS. 2, 3 and 9 represent capsules made up of multiple semi-capsules 1, 1′ and 3, with different shapes and sizes and a substrate 2, capsule.

The agrochemical 7 used in the present invention may be chosen between pesticides, fungicides, herbicides, growth controller, fertilizer, growth stimulant, inoculation. These agrochemicals 7 may be in the capsules in liquid, solid, gel or any other form that is desired, and may be a part of the capsule composition or be a material packed by the capsule or even be present in the lining of the biological material of a vegetative source. Further, biological, antibiotic, antiviral, ultraviolet filters, pesticides, fertilizers, osmotic gels or a mixture of these may be added to the capsule.

In a modality the preferred invention the capsule encompasses the following components: up to 20% in weight of agrochemical 7, up to 25% in weight of osmotic gel, up to 20% in weight of growth controller gel, up to 70% in plasticizer weight, from 5% to 70% of structural ingredients in weight, 1% to 30% in agglomerating weight, 0.5% to 50% in water weight, up to 40% in weight of a humidifying agent, up to 5% in weight of pigments/coloring, up to 10% in weight in preservatives, up to 5% in weight for markers, in relation to the total weight of the capsule.

As non-limiting examples the following are recommended agrochemical 7, pesticides: thiran, imidacloprid, metalaxil, fluodioxonil, iprodi-one, imebenconazol and/or carbendazin. Also fertilizers such as N, P, K B, Mg and/or micronutrients are employed. Vegetation hormones 6-furfurilaminoadenida, naphthaleneacetic acid, ethylene, gibberellic, indolylacetic acid, among others.

The use of these pesticides in the capsule aims to cut out the conventional spraying steps, so as to prevent waste when these are applied over the field. This application is at present carried out in a random manner without precise control and the exact quantity applied over the field, there is no guarantee that the entire field receives the minimum necessary application of the agrochemicals 7, or even if it is receiving a quantity that is greater than that which is desired, besides the fact that when the capsules are used, this has the guarantee that the agrochemicals are not applied directly over the biological material of a vegetative source. Therefore the packing of a biological form of a vegetative source, such as seed and/or embryo and/or spore and/or callose and/or meristem and/or a combination of these 4 with pesticides, prevents waste with the indiscriminate use of agrochemicals 7, and offers greater productivity to the harvest.

The agrochemicals 7, that may be combined, have a function of controlling the various pathogens such as fungi that cause damping off, Fusarium spp, Rizoctonia solani, Sclerotinia sclerotiorum, Phytophtora capsici. Depending on the agrochemical 7 used, this may exempt the first spraying applications, in the case of the use of systemic products or long duration products.

The capsules packing of any biological form of a vegetative source 4 containing agrochemicals 7 are efficient for the cultivation of certain cultures that have specific usage needs, with the cultivation, a chemical/biological product that complies with the producer's needs, such as safety in handling the agrochemicals 7 when planting or sowing on a substrate.

The capsule for packing of any biological form of a vegetative source 4 may also contain an attached electrical heating element, with the objective of heating the capsule to an ideal temperature for a certain cultivation, mainly for planting in cold locations or under the influence of harsh winters.

The capsules in this invention may also encompass mineral, physical/chemical and/or biological trackers, which facilitate the identification of the biological form of a vegetative source 4, allowing the producer to better identify the products, for example, seeds, “original”, guaranteeing the quality of the final product and greater productivity in the harvest.

The capsules also allow for the packaging of scents with the objective of chasing away possible animals that come to feed on the biological form of a vegetative source 4 thus prejudicing the planting, also thus avoiding losses in the sowing productivity. The capsules may also have specific colors to attract or repell pests according to the producer's interests.

The capsule may also contain a substrate 2 inside it. In this manner, the capsule aids the cultivation of plantings in soils lacking the ideal quantity of nutrients, thus increasing the useful area for planting, production and harvesting.

According to FIGS. 12 and 13, part of the make up of semi-capsule 1 may contain a compacted substrate 2, which dilates when it comes into contact with humidity and/or water, transforming it into a dilated and humid substrate 10. The humid and dilated substrate 10 format serves for root development, and, in the case of cultures where the plants do not have enough strength to break the capsules, the humid and dilated substrate 10 also serves to help break or dissolve the adjacent semi-capsules, the broken capsule 11 being biodegradable and therefore does not generate pollution problems to the substrate, such as the soil.

Another option as represented by FIGS. 4 and 5 is that the inside of one of the semi-capsules 1 and 1′, and/or both, contain substrate 2 together with the seeds 4 for germination and development of the first phases of the vegetative cycle. This configuration of the invention allows for two modalities of the invention:

1^{st}—Inside the capsule(s) there may be natural substrates 2, from compressed peat and/or other natural and/or artificial substrates 2 from coconut fibers, cotton fibers and/or any other substrate 2 used in agriculture, including, but not limited to, sand or other sands combined with any other natural and/or artificial substrate 2 (such as glass fiber, silica, gel, etc) and/or natural and/or processed clays such as (kaolin, montmorillonite, smectite, talcum, vermiculite, mica, sepiolite, bentonite, pumice stones, among others);

2^{nd}—As illustrated in FIG. 6, instead of semi-capsule 1 being filled with substrates 2, the semi-capsule 1 may be substituted for a compacted substrate 2 cylinder with the same form as the other semi-capsule(s), which may contain natural substrate 2, of compressed peat and/or other substrates 2 from coconut fiber and/or any substrate 2 used in agriculture, including, but not limited to, sand or other sands combined with any other natural and/or artificial substrate 2, such as glass fiber, silica gel etc) and/or natural and/or processed clays (kaolin, montmorillonite, smectite, talcum, vermiculite, mica, sepiolite, bentonite, pumice stones, among others), to favor a germination and growth.

Both in the 1^{st} as well as the 2^{nd} modality, semi-capsules 1, 1′ and 3 may be a solid or semi-solid structure with adequate dimensions for it to fit into another semi-capsule 1, 1′ and 3. Semi-capsules 1, 1′ and 3 of the present invention may be joined together through pressure or with an adhesive applied to the surface.

In contact with water and/or an aqueous solution, substrate 2 packed in the capsule is able to absorb a number of times its specific weight in water. Substrate 2 may be combined with substances such as pesticides and/or selective herbicides, and/or fertilizers and/or growth regulating hormones (naphthaleneacetic acid, indolylacetic acid, and indol butyric acid), represented in FIG. 8 by item 7, which favors root development.

In FIG. 15, the capsules may be segmented in enclosed and independent compartments 13, which means that different substances may be physically separated in one or various enclosed chambers 13. Such enclosed chambers 13 may contain the culture medium, for example agar-agar, which contains other molecules and/or microorganisms (fungi and bacteria) symbiotic or non symbiotic, saprophytes and/or non saprophytes that may or may not be associated, to control root growth in the first stages of vegetative growth. These substances may be released according to a sequence of pre-established time.

In another enclosed chamber 13 there may be growth stimulation gasses, fertilizers; in another chamber there may be pesticides, fungicides, antibiotics and antivirals. All of the components added to the enclosed chambers 13 which are physically separated, and will only become available when the enclosed chambers 13 break, or may also come into contact through permeability between the compartments.

The use of enclosed chambers 13 inside the capsules allows for greater spacing control of the agrochemicals 7 over any biological form of a vegetative source, such as seeds and/or embryos and/or spores and/or callose and/or meristems and/or a combination of these 4, in such a manner as to prevent direct contact with it. This control over the spacing becomes necessary as in some cases the direct contact with the agrochemical 7 may prejudice the planting.

On using microorganisms in the enclosed chambers 13, one may create a micro-fauna or flora for better vegetative development of the species included in the capsules. This may also be used to control certain competitive and/or invasive plants.

As the capsules and semi-capsules 1, 1′ and 3 of this invention are not of a pharmacological and medical use, the chemical and physiochemical flexibility in its composition and in its manufacturing process is of special interest. The flexibility of the capsules prevents its breakage and allows them not to break under 300 gf of pressure, as in the case of transporting it in capsules with seeds bags, where the capsules at the bottom of the bag are subject to a column pressure of the capsules. The capsules are designed to disintegrate and increase their flexibility when they come into contact with water. The flexibility of the capsules also guarantees that they support frictional forces and/or vacuum on sowing machines that exist on the market today.

The present invention also refers to a method for preparing a capsule, encompassing the steps of mixing at least one agrochemical 7 with the structural ingredients for the abovementioned capsule.

During the preparation of the final formulation, the inclusion of solids pesticides and/or biocides requires adjustment to the final quantities of the other structural ingredients to increase the capsules and/or semi-capsules 1, 1′ and 3 permeability and porosity. The manner in which the pesticide is applied in the mixture's preparation as a wettable powder, this will be considered as a structural ingredient for permeability. In case the pesticide is applied as a liquid, this will then not be considered as a structural ingredient for the purposes of the invention.

During the preparation of the final formulation, the inclusion of fertilizers requires adjustment to the final quantities of the other structural ingredients to increase the capsules and/or, semi-capsules 1, 1′ and 3 permeability and porosity. The manner in which the potassium nitrate and/or other fertilizer is applied in the preparation of the mixture, this will be considered as a structural ingredient for permeability. The same manner and application when the final formula mixture is done with triple fertilizers (NPK), including lesser micronutrients.

During the preparation of the final formulation, the inclusion of solid pigments and/or coloring requires adjustment to the final quantities of the other structural ingredients to increase the capsules and/or semi-capsules 1, 1′ and 3 permeability and porosity.

According to the specifications of the included herbicides as structural material for the capsule, this will work specifically over weeds over which control is required, as for example, selective and specific herbicides for the control of monocotyledonous herbs (2.4 D; glyphosate) and/or others, may be used for dicotyledonous seeds packed in the capsule.

The structural ingredients to increase permeability and porosity of the capsules in a non-limiting mode are: diatomaceous earth or micron sized diatomite (with a particle size smaller than, but not limited, to 100 microns), micron sized perlite (with a particle size smaller than, but not limited to, 100 microns), talcum and other hydrated magnesium silicates (sepiolite, attapulgite), kaolinitic clays, montmorillonitic clays, bentonitic clays, illite, smectite, dolomites, calcium carbonates, wollastonite, quartz, crystallized feldspars and amorphous feldspars and calcium sulfates dehydrated and e semi-hydrated, muscovite micas, biotitic micas, lepidolite micas or combinations of these.

The capsules and semi-capsules 1, 1′ and 3 may be of animal origin (gelatin based), vegetative source (gum Arabic, carrageenates, vegetable base gums and starch derivates), from synthetic sources or combinations of these.

For gelatin, vegetable gums, starch derivates based and/or synthetic based formulations, the presence of inert loads of a silicate and or mineral origin favor the disintegration of the capsule during its contact with water, maintaining elevated porosity of the capsular structure.

Due to its chemical and structural content the capsules are biodegradable, where, through the use of pesticides and/or others components, it is possible to control the degradation speed of the capsules after it comes into contact with these with water and the soil.

Amongst the great quantity of possible agglomerating substances but not limited to the invention are: gelatin (30 to 70% p/p), carrageen and carrageenates (30 to 70% p/p), gum starch (10 to 50% p/p), vegetable based gums (10 to 50% p/p), glycerin (5 to 20% p/p), polyvinylpyrrolidone or PVP (2 to 15% p/p), methylcellulose (2 to 15% p/p), glycol polyethylene greater than one PM in 2000 (for example, 6000 and 8000) (5 to 25% p/p), magnesium stearates and/or calcium (1 to 10% p/p), being that the percentages here presented in relation to the total weight of the capsule's composition.

When all of the ingredients are measured a suspension and/or gel is prepared with hot water until a homogenous and humid mass is obtained. The addition of, but not limited to, Twin-80 surfactant may improve the processing and/or preparation of the capsules and/or semi-capsules 1, 1′ and 3 during the use of the molds and semi-molds.

The mixture of agrochemicals 7 with structural ingredients undergoes an extrusion process, at a temperature above 36° Celsius but lower than 80° Celsius, to prevent premature clots forming and/or some of the components precipitate. After applying the ingredients to the molds these must be cooled to temperatures below 35° Celsius.

The present invention also refers to a packaging method of any biological form from a vegetative source, such as seed and/or embryo and/or spore and/or callose and/or meristem and/or a combination of these 4 in a capsule, this method encompasses the feeding step of the above described capsule with at least one biological material of a vegetative source, such as seed and/or embryo and/or spore and/or callose and/or meristem and/or a combination of these 4.

The packaging process may be applied to flower, vegetables, forestry, legumes, fruit and cereals varying the dimensions from 85,000 seeds/gram of seed to less than one seed/gram of seed, as for example maize seeds.

The present invention also refers to a culture cultivation method where the capsule as defined above is applied to substrate. Such as soil. The said capsule may be applied over the substrate in a vertical or horizontal position. To facilitate the horizontal or vertical direction of the capsule on the substrate or soil 9, an inert material 8 may be added inside the capsule to give it “weight”, guaranteeing the farmer that the capsules are sown in the position of greatest interest to achieve greater productivity at the harvest, with this configuration of the invention being illustrated by FIGS. 10 and 11.

The germination of any biological form of a vegetative source seeds, such as embryos and/or spores and/or callose and/or meristems and/or a combination of these 4 occurs in normal processes with the 1^{st} phase of wetting the capsule which partially melts in the lower section and following which the wetting of the pellet. This wetting of the pellet maintains the necessary humidity for germination. The big difference in the germination process is that the capsule maintains the determined quantity of oxygen for the seeds to breathe, and for this reason it may be sown directly into the phenolic foam that will go to the hydroponics pipes. The same criteria used in the germination of encapsulated seeds are applied to shelled seeds.

Hydroponic cultivation may be used as the objective of reducing one of the nursery steps as the capsules may go directly into the phenolic foam and placed in the hydroponics pipes, resulting in less planting time and allowing the farmer a greater number of harvests over the same period of time.

In cultivating seedlings, these may be sown directly into the soil by means of sowing machines, or in polystyrene trays in which the cells holding the substrate are to be found and may be peat, coconut fiber, humus or other substrate or sowing medium. Sowing into the trays may be done manually or with pneumatic or perforated disc sowers (cereals sowers), according to the species and objective for which it is destined.

### EXAMPLE 1

An experiment was carried out to evaluate the performance of pelletized watercress seeds and packed so as to compare it with shelled watercress seeds. This experiment was carried out using the following materials:
1. Coconut fiber substrate;
2. Polystyrene trays with 128 cells;
3. Phenolic foam;
4. Hydroponic cultivation table;
5. Shelled watercress seeds;
6. Pelletized and encapsulated watercress seeds.

The watercress seeds in item 6 were pelletized with a diameter of 0.85 to 1.2 mm and packed in a standard size 004 gelatin capsules, each capsule in the experiment held 50 pelletized seeds.

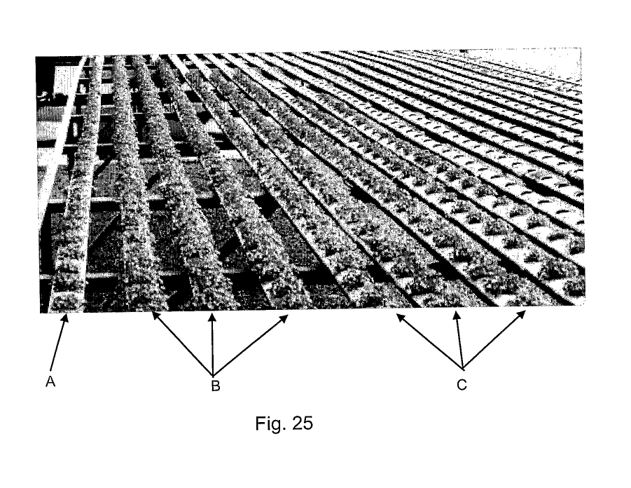

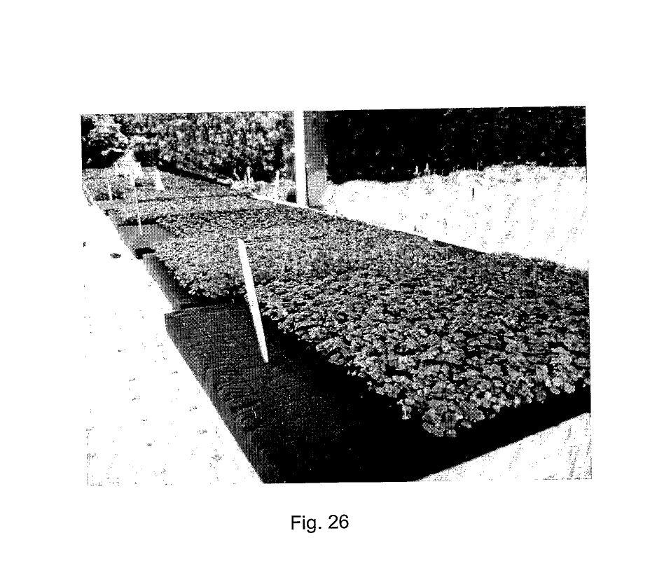

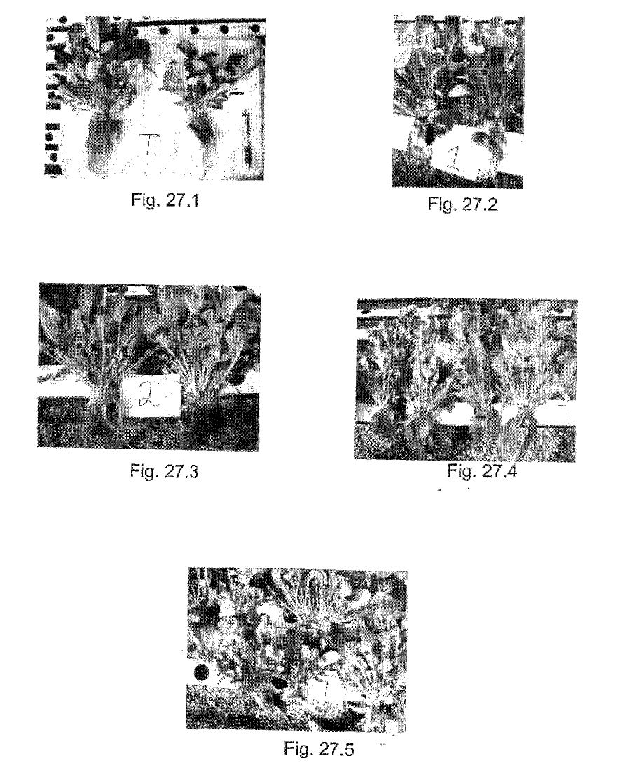

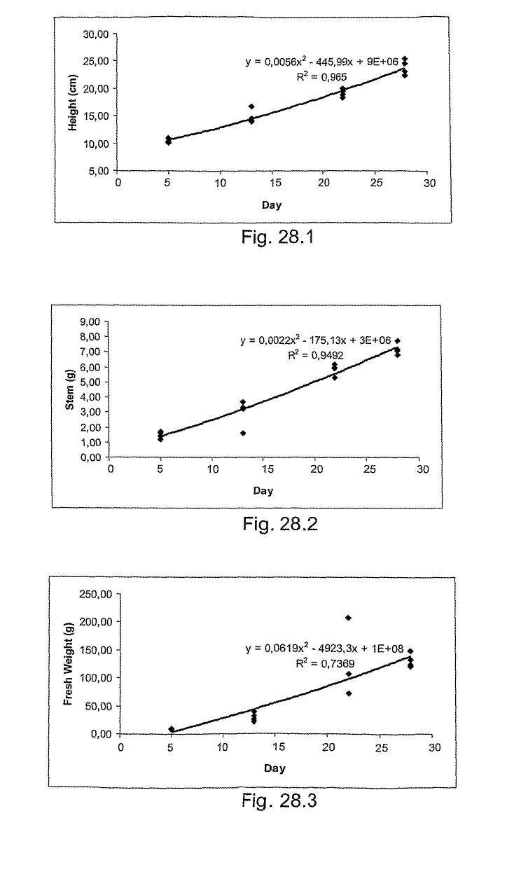

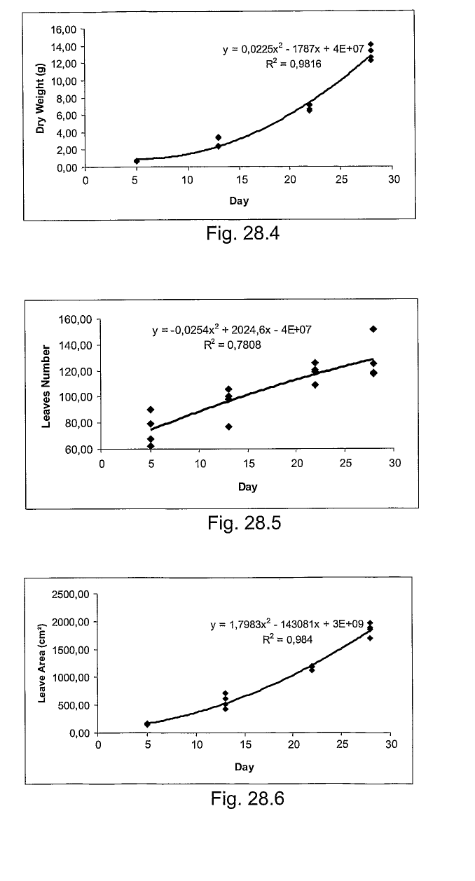

Both forms of seeds, shelled and packed, were sown in the coconut fiber substrate and the phenolic foam (floral) in different combinations, one at nursery stage in a tray, as illustrated in FIG. 17, to be transplanted to the pipes later, and the other sowing directly into phenolic foam hydroponic pipes, this second sowing is illustrated by FIG. 25 where A represents plantings of shelled seeds, B plantings of horizontally packed seeds and C plantings of vertically packed seeds.

The seeds cultivated in the hydroponics system start to receive nutrients the moment they enter the “nursery” (4 to 6 days after being sown), but the foam itself goes directly to the hydroponic pipes without changing the substrate. The seeds cultivated in the tray system may undergo stress the moment they are transplanted thus delaying their development.

In FIG. 17, fiber substrates were placed in polystyrene trays normally used by vivariums and farmers, the shelled seeds A were sown directly with 50 seeds as the control experiment, and the seeds in capsules were sown in the horizontal position B and vertical position C.

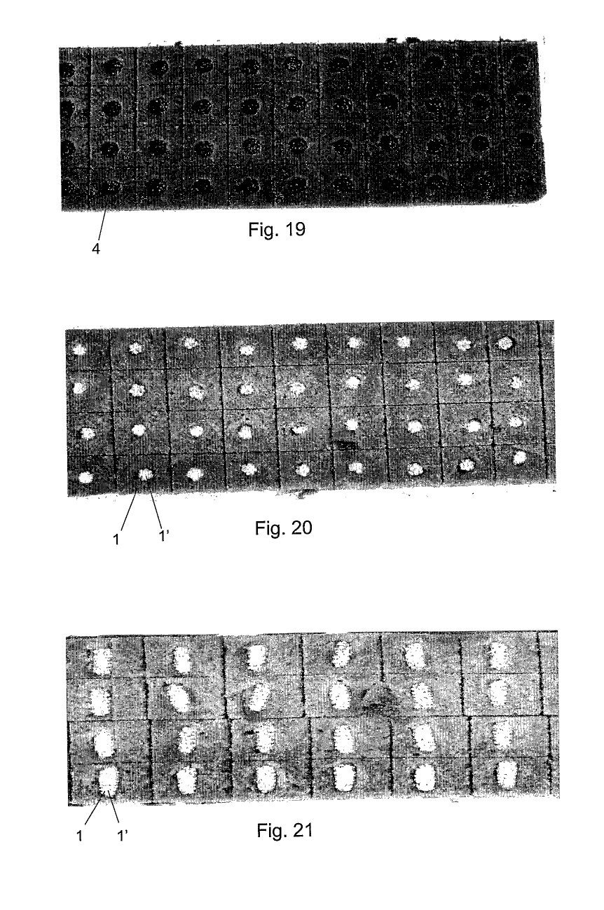

FIG. 19 shows an expansion of the shelled seeds placed in fiber substrates in polystyrene trays, whilst FIG. 20 illustrates the capsules with seeds placed vertically in the substrate and FIG. 21 shows the capsules with seeds placed horizontally in the substrate.

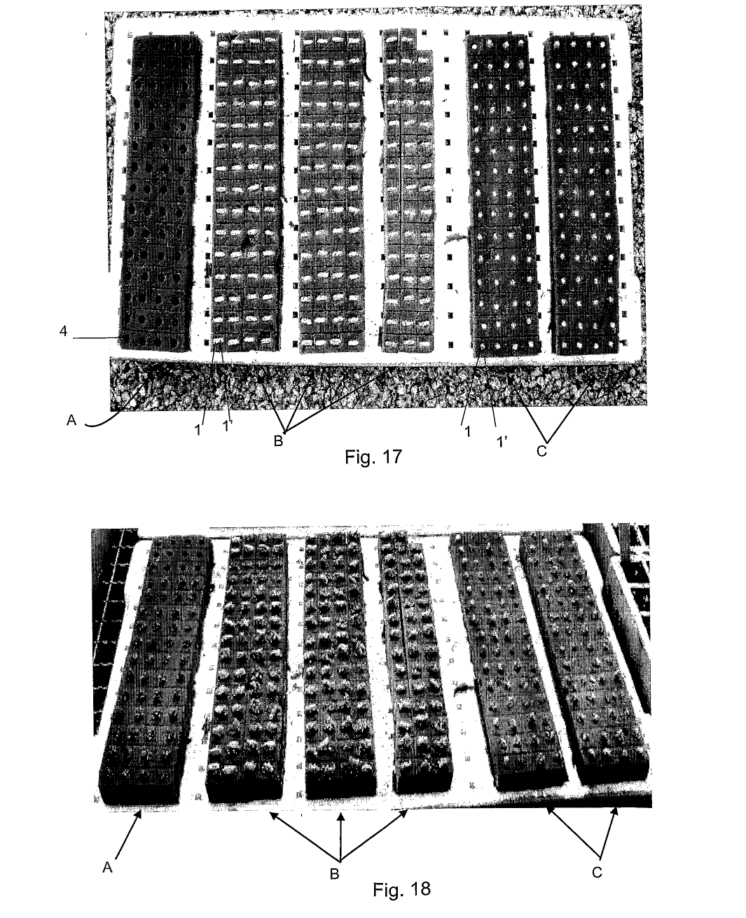

Evaluations on the experiment were carried out in the seedling phase, between 7 to 10 days, in the form of visual analysis, observing the growth of each modality and comparing it to the control (shelled seeds) in coconut fiber substrate and phenolic foam as illustrated in FIG. 18.

In this visual analysis it was observed that the seedlings originating from encapsulated pelletized seeds had more strength, with a stronger green coloring and their leaves more developed when compared to the shelled seeds.

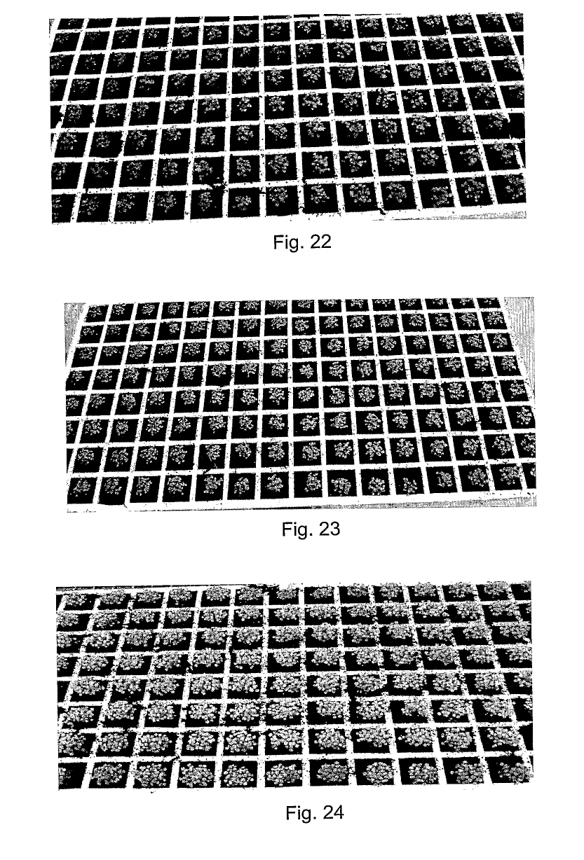

Evaluations on the fresh weight and length of the plant were carried out at the end of the 32-day cycle. The results obtained are shown in table 1, where the shelled seeds (control), FIG. 21, are compared to the pelletized and encapsulated seeds in the vertical position, FIG. 22, and in the horizontal position, FIG. 23. The comparison was made as to the fresh weight (in grams) and the length of the plant (in centimeters).

TABLE 1
COMPARISON OF WATERCRESS SEEDS IN
ITS SHELLED, ENCAPSULATED AND PELLETIZED
FORM AFTER A 32-DAY CYCLE

| | | Fresh | Plant |
|---|---|---|---|
| Substrate | Treatment | weight (g) | length (cm) |
| Coconut Fiber | Shelled | 18 | 9 |
| | (control) | | |
| Hydroponics | Shelled | 95 | 28 |
| (phenolic foam) | (control) | | |
| Coconut Fiber | Vertical Capsule | 57 | 16 |
| Hydroponics | Vertical Capsule | 96 | 35 |
| (phenolic foam) | | | |
| Coconut Fiber | Horizontal Capsule | 62 | 18 |
| Hydroponics | Horizontal Capsule | 124 | 42 |
| (phenolic foam) | | | |

By analyzing the table, one can see that the horizontal sowing had better fresh weight and length results of the plant when compared to the vertical sowing, these results were observed both for the expansion in the tray cell as for the expansion in the phenolic foam. Through this data, one can conclude that the pelletized and encapsulated seeds sown in the horizontal position present better development and less time spent per cycle.

During the sowing, one can notice innumerable advantages in the packing of the pelletized seeds as one big factor and greater facility for sowing, better uniformity in the number of final plants to obtain a bunch, reduction in costs due to not using the tray step, increase in the plant's biomass and considerable increase in the length of the plants.

The difference in weight and biomass of the pelletized and packed seeds in relation to the shelled seeds suggest a 25-day cycle, that is, a reduction of 7 days to harvest, seeing that the farmer normally harvests 32 days after sowing.

The reduction in the cycle time to 25 days allows the farmer 14.6 harvests from one hydroponics table per year, that is, 28% more in terms of profitability, in seeing that in the normal cycle of 32 days the farmer only obtains 11.4 harvests from one hydroponics table per year.

### EXAMPLE 2

The objectives of this example 2 were: evaluate the effects of pelletization with or without agrochemicals (fertilizers and Ecogel) and the packaging of seeds in capsules for the production of arugula cultivated in hydroponic system.

Arugula' seedlings of cultivar Large Leaf Arugula were produced in phenolic foam, as shown in the picture 26.

The experiment was composed of five treatments and four replications in randomized complete block design. The treatments were: nude seed (Control treatment-T), pelleted seeds in capsule (Treatment 1), pelleted seeds with 9 mg of 04-14-08, 9 mg of thermophosphate and 2 mg of Ecogel in capsule (Treatment 2), pelleted seeds with monoamonium phosphate (2% of weight seeds) in capsule (Treatment 3) and pelleted seeds with monoamonium phosphate (2% of weight seeds), 9 mg of 04-14-08, 9 mg of thermophosphate and 2 mg de Ecogel (Treatment 4).

Each plot was composed of 32 useful plants, spaced in 20 cm between plants and 20 cm between rows, arranged in channels of polypropylene. In a first day the seedlings with seven days of age were transferred to the nursery composed by channels of polypropylene.

Eight plants of each plot were collected in approximately weekly intervals in a total of four periods, to determine the plants height, petiole length, leaf number, shoot's fresh weight and leaf area. To determine the leaf area was used an integrator of leaf area (LI-3100 Area Meter).

The root's system was not analyzed according to the loss of root during the process of washing for the withdrawal of the substrate.

### EXPERIMENT CONDUCED IN PHENOLIC FOAM

In picture 27 are the plants' aspects relating to the treatments T, 1, 2, 3 and 4.

The results of plant height stem length, fresh weight and dry weight of shoot, number of leaves and leaf area of arugula plants, at 8, 16, 25 and 31 days after the seedlings' transplant are found in the tables 2, 3, 4 and 5, respectively.

In the first evaluation, all treatments provided greater plant higher, fresh weight, dry weight, number of leaves and leaf area compared to the control (Table 2). For fresh weight, dry weight, number of leaves and leaf area, treatment 2 was superior to treatments 3 and 4 probably by potassium in 04-14-08 fertilizer, calcium, magnesium and micronutrients in thermophosphate. In the second and third evaluation, all treatments were superior to control for the fresh weight, dry weight, number of leaves and leaf area. Treatment 2 provided greater leaf area than the others at 16 days after the transplant of seedlings. In the harvest period, all treatments were similar and higher than the control for the fresh weight, dry weight, number of leaves and leaf area.

TABLE 2
PLANT HEIGHT, STEM LENGTH, FRESH WEIGHT AND DRY WEIGHT
OF SHOOT, NUMBER OF LEAVES AND LEAF AREA OF ARUGULA
PLANTS AT 8 DAYS AFTER TRANSPLANTING SEEDLINGS.
SEEDLINGS

| Treatment | Height | | Stem | | Fresh Weight | | Dry Weight | | Leaves Number | | Leaf Area | |
|---|---|---|---|---|---|---|---|---|---|---|---|---|
| T | 22.82 | A | 6.85 | A | 94.30 | A | 8.92 | A | 100.12 | A | 1462.56 | A |
| 1 | 23.90 | AB | 6.89 | A | 124.45 | B | 13.30 | B | 118.68 | B | 1894.095 | B |
| 2 | 23.95 | AB | 7.20 | A | 132.84 | B | 13.04 | B | 127.87 | B | 1851.77 | B |
| 3 | 24.18 | AB | 7.15 | A | 127.82 | B | 12.69 | B | 122.87 | B | 1841.51 | B |
| 4 | 25.21 | B | 7.17 | A | 136.49 | B | 12.50 | B | 131.03 | B | 2089.90 | B |

| | | | | | | |
|---|---|---|---|---|---|---|
| CV (%) | 12.58 | 15.81 | 25.14 | 22.44 | 20.02 | 25.58 |
| (variance coefficient) | | | | | | |
| D.M.S | 2.085 | 0.770 | 21.376 | 1.873 | 16.593 | 322.846 |

TABLE 3
PLANT HEIGHT, STEM LENGTH, FRESH WEIGHT AND DRY WEIGHT
OF SHOOT, NUMBER OF LEAVES AND LEAF AREA OF ARUGULA
PLANTS AT 16 DAYS AFTER TRANSPLANTING SEEDLINGS

| Treatment | Height | | Stem | | Fresh Weight | | Dry Weight | | Leaves Number | | Leaf Area | |
|---|---|---|---|---|---|---|---|---|---|---|---|---|
| T | 12.25 | A | 2.32 | A | 12.82 | A | 1.16 | A | 65.28 | A | 245.37 | A |
| 1 | 14.78 | B | 2.73 | B | 25.20 | B | 2.46 | B | 94.09 | B | 486.36 | B |
| 2 | 14.89 | B | 2.95 | B | 25.20 | B | 2.87 | B | 95.09 | B | 570.33 | C |
| 3 | 14.55 | B | 2.77 | B | 29.09 | B | 2.44 | B | 86.28 | B | 490.71 | B |
| 4 | 14.45 | B | 2.90 | B | 25.81 | B | 2.48 | B | 92.40 | B | 490.09 | B |

| | | | | | | |
|---|---|---|---|---|---|---|
| CV (%) | 11.2 | 17.68 | 25.61 | 23.37 | 15.79 | 24.65 |
| (variance coefficient) | | | | | | |
| D.M.S | 1.097 | 0.334 | 4.236 | 0.371 | 9.443 | 77.7 |

TABLE 4
PLANT HEIGHT, STEM LENGTH, FRESH WEIGHT AND DRY WEIGHT
OF SHOOT, NUMBER OF LEAVES AND LEAF AREA OF ARUGULA
PLANTS AT 25 DAYS AFTER TRANSPLANTING SEEDLINGS

| Treatment | Height | | Stem | | Fresh Weight | | Dry Weight | | Leaves Number | | Leaf Area | |
|---|---|---|---|---|---|---|---|---|---|---|---|---|
| T | 17.08 | A | 5.20 | A | 46.83 | A | 3.87 | A | 88.25 | A | 731.26 | A |
| 1 | 19.70 | B | 5.62 | AB | 76.91 | B | 7.51 | C | 124.87 | B | 1262.14 | C |
| 2 | 19.24 | B | 5.85 | B | 83.17 | B | 6.76 | BC | 118.71 | B | 1165.71 | BC |
| 3 | 19.79 | B | 6.01 | B | 73.87 | B | 6.29 | B | 117.34 | B | 1090.53 | B |
| 4 | 18.55 | AB | 5.48 | AB | 71.70 | B | 6.16 | B | 114.46 | B | 1057.50 | B |

| | | | | | | |
|---|---|---|---|---|---|---|
| CV (%) | 12.26 | 14.24 | 24.75 | 22.11 | 15.96 | 22.64 |
| (variance coefficient) | | | | | | |
| D.M.S | 1.59 | 0.56 | 12.048 | 0.934 | 12.418 | 165.887 |

TABLE 5
PLANT HEIGHT, STEM LENGTH, FRESH WEIGHT AND DRY WEIGHT
OF SHOOT, NUMBER OF LEAVES AND LEAF AREA OF ARUGULA
PLANTS AT 31 DAYS AFTER TRANSPLANTING SEEDLINGS

| Treatment | Height | | Stem | | Fresh Weight | | Dry Weight | | Leaves Number | | Leaf Area | |
|---|---|---|---|---|---|---|---|---|---|---|---|---|
| T | 22.82 | A | 6.85 | A | 94.30 | A | 8.92 | A | 100.12 | A | 1462.56 | A |
| 1 | 23.90 | AB | 6.89 | A | 124.45 | B | 13.30 | B | 118.68 | B | 1894.095 | B |
| 2 | 23.95 | AB | 7.20 | A | 132.84 | B | 13.04 | B | 127.87 | B | 1851.77 | B |
| 3 | 24.18 | AB | 7.15 | A | 127.82 | B | 12.69 | B | 122.87 | B | 1841.51 | B |
| 4 | 25.21 | B | 7.17 | A | 136.49 | B | 12.50 | B | 131.03 | B | 2089.90 | B |

| | | | | | | |
|---|---|---|---|---|---|---|
| CV (%) | 12.58 | 15.81 | 25.14 | 22.44 | 20.02 | 25.58 |
| (variance coefficient) | | | | | | |
| D.M.S | 2.085 | 0.770 | 21.376 | 1.873 | 16.593 | 322.846 |

For plant height, petiole length, leaf number, fresh weight, dry weight and leaf area was adjusted quadratic regression equations, showing that, in general, the development of plants was slow until 18 days after transplanting seedlings to the final channel, being accelerated from that period for all treatments, including the control. Picture 28 shows this behavior for plants of the treatment 2.

With example 2 one may conclude that the use of pelleted seed packed in capsules as teachings of this invention allows further development of arugula plants grown in hydroponic system, from seedlings obtained from phenolic foam.

1. A capsule, for the cultivation of a culture, characterized by the fact that it packs any biological form of a vegetative source, the capsule comprising agrochemical in its composition.

2. The capsule, according to claim 1, characterized by the fact that the form of the vegetative source is chosen from the group consisting of at least one seed, embryo, spore, callose, meristem, and a combination of these (4) of at least one culture.

3. The capsule, according to claim 1, characterized by the fact that a seed is a shelled seed, lined seed, palletized seed, film coated seed, encrusted seed or a mixture of these.

4. The capsule, according to claim 1, characterized by the fact that the vegetative source is a seed that is germinated, pre-germinated or non-germinated.

5. The capsule, according to claim 4, characterized by the fact that a culture is chosen from the group consisting of vegetables, flowers, cereals, fruit, legumes, and forestry cultures.

6. The capsule, according to claim 1, characterized by the fact that it presents void varying from 1% to 99% in volume of the total volume of the capsule.

7. The capsule, according to claim 6, characterized by the fact that it contains gases chosen from the group gasses consisting of air, oxygen, ethylene or a mixture of these.

8. The capsule, according to claim 1, characterized by the fact that contains water.

9. The capsule Capsule, according to claim 1, characterized by the fact that it presents a porosity of up to 50%.

10. The capsule, according to claim 1, characterized by the fact that it is made up of at least two semi-capsules.

11. The capsule, according to claim 10, characterized by the fact that it presents a thickness of around 15 microns to 250 microns.

12. The capsule, according to claim 10, characterized by the fact that it presents a spherical, cylindrical, circular, oblong, flat or oval shape.

13. The capsule Capsule, according to claim 1, characterized by the fact that the agrochemical is chosen from pesticide, fungicide, herbicide, growth controller, fertilizers, growth stimulants or a mixture of these.

14. The capsule, according to claim 1, characterized by the fact that it encloses biological, antibiotic, antiviral, ultraviolet filters, osmotic gels, micronutrients, vegetation hormones or a mixture of these materials.

15. The capsule, according to claim 1, characterized by the fact that an electrical element may be coupled to the surface.

16. The capsule, according to claim 1, characterized by the fact that it encompasses up to 20% of its weight in agrochemical, up to 25% of the weight in osmotic gel, 20% of the weight in growth controller gel, up to 70% of the weight in plasticizer, from 5% to 70% of the weight in structural ingredients, 1% to 30% in weight of agglomerate, 0.5% to 50% of the weight in water, up to 40% of the weight in humectants, up to 5% of the weight in pigments/coloring, up to 10% of the weight in preservatives, up to 5% of the weight in markers, in relation to the total weight of the capsule.

17. The capsule Capsule, according to claim 1, characterized by the fact that it presents a resistance of at least 300 gf (grams/square cm).

18. The capsule, according to claim 1, characterized by the fact that it packs a substrate (2).

19. The method to prepare a capsule as defined in claim 1, characterized by the fact that encompasses the step to (i) mix at least one agrochemical with structural ingredients.

20. The method, according to claim 19, characterized by the fact that it encloses at least one osmotic gel, growth controller gel, plasticizer, structural ingredient, agglomerate, humectants, pigments/coloring, preservatives or markers.

21. The method, according to claim 19, characterized by the fact that it encompasses (ii) extruding the mixture obtained in step (i) at a temperature varying between 36° C. to 80° C., and (iii) cooling to a temperature below 352 C after molding it.

22. A packing method of any biological form of a vegetative source in a capsule, as defined in claim 1, characterized by the fact that it encompasses feeding at least one biological form of a vegetative source in a capsule.

23. A culture cultivation method, characterized by the fact that it encompasses applying to the substrate a capsule as defined in claim 1.

24. The method according to claim 23, characterized by the fact that the capsule is applied to the substrate in a vertical or horizontal position.

25. The use of a capsule for packing any biological form of a vegetative source as defined in claim 1, characterized by the fact that it may be applied horizontally or vertically to the substrate to cultivate a culture.

26. The use, according to claim 25, characterized by the fact that the form from a vegetative source is chosen from the group consisting of at least one seed, embryo, spore, callose, meristem, and a combination of these (4) of at least one culture.

27. The use, according to claim 25, characterized by the fact that the vegetative source is a seed that is germinated, pre-germinated or non-germinated.

28. The use, according to claim 25, characterized by the fact that the culture that is chosen from vegetables, flowers, cereals, fruit legumes, forestry cultures or a mixture of these.

29. The capsule, according to claim 1 characterized by the fact that it includes agrochemical.

30. The capsule, according to claim 1, characterized by the fact that it is made up of at least two semi-capsules made up of enclosed compartments, presenting a varying length of around 2 mm to 50 mm and a diameter varying from around 2 mm to 50 mm.
